(19) United States
(12) Patent Application Publication
(10) Pub. No.: US 2006/0076814 A1
(43) Pub. Date: Apr. 13, 2006

(54) Adjustable backrest on personal mobility aid

(76) Inventors: Ivan Samila, Richmond Hill (CA); Judy A. Rowley, Kitchener (CA)

Correspondence Address: CALFEE HALTER & GRISWOLD, LLP, 800 SUPERIOR AVENUE, SUITE 1400, CLEVELAND, OH, 44114, US

(21) Appl. No.: 10/961,017

(22) Filed: Oct. 8, 2004

(51) Int. Cl. B60N 2/02

(52) U.S. Cl. 297/354.12

(57) ABSTRACT

An adapter assembly for releasably attaching a backrest to a frame member, such as a back cane, of a personal mobility device, such as a wheelchair, includes a clamp that can be releasably clamped on the back cane, and a bracket that can be releasably engaged with the backrest, the bracket having a plurality of openings. A plurality of fasteners extend from the clamp through the openings in the bracket. The fasteners have a first condition securing the bracket from movement relative to the clamp and having a second condition enabling adjustment of both the front to back position and the angular position of the backrest relative to the back cane.

### TECHNICAL FIELD

The present invention relates to an adjustable backrest on a personal mobility aid, such as a wheelchair, and to an adapter assembly for supporting a backrest to be adjustable on a personal mobility aid in both a front to back direction and in an angular direction.

### BACKGROUND OF THE INVENTION

Wheelchairs with adjustable backrests are known. Such wheelchairs typically have two back canes (upright posts) that support the backrest in position relative to the other parts of the wheelchair, such as the seat bottom cushion and the wheels. One known type of adjustable backrest is the Invacare Personal Back. The backrest can be set at different front-to-back positions and also at different angular orientations relative to the back canes. Another known type of adjustable backrest is the Invacare Infinity Back Support. In this unit, the backrest can be set at different angular orientations and front to back positions relative to the back canes. In both cases, multiple adjustments of different fasteners are needed to make these changes.

### SUMMARY OF THE INVENTION

The invention in one aspect relates to an adapter assembly for releasably attaching a backrest to a frame member, such as a back cane, of a personal mobility device, such as a wheelchair. The adapter assembly comprises a clamp that can be releasably clamped on the back cane, and a bracket that can be releasably engaged with the backrest, the bracket having a plurality of openings. A plurality of fasteners extend from the clamp through the openings in the bracket, the fasteners having a first condition securing the bracket from movement relative to the clamp and having a second condition enabling adjustment of both the front to back position and the angular position of the backrest relative to the back cane.

In another aspect the invention relates to a method of changing the position of a side portion of a wheelchair backrest relative to a wheelchair back cane, the wheelchair including two fasteners that are operatively located on a first one of the backrest and the back cane and that are received in two generally parallel slots operatively located on the second one of the backrest and the back cane. The method includes the steps of making the front to back position and the angular position of the backrest side portion adjustable relative to the back cane by loosening the two fasteners; moving the fasteners in the slots thereby to adjust one or both of the front to back position and the angular position of the backrest side portion relative to the back cane; and tightening the fasteners thereby to secure the backrest side portion in the selected position relative to the back cane.

### BRIEF DESCRIPTION OF THE DRAWINGS

The foregoing and other features of the invention will become apparent to one of ordinary skill in the art to which the invention pertains, upon reading of the following description in conjunction with the accompanying drawings, in which:

FIG. 1 is an illustration of a personal mobility device in the form of a wheelchair that including an adjuster assembly in accordance with a first embodiment of the invention;

FIG. 2 is FIG. 2 is a side elevational view of the adjuster assembly;

FIG. 3 is a side elevational view of the adjuster assembly shown attached to a schematically illustrated back cane and backrest;

FIGS. 4 through 6 are views similar to FIG. 3 showing the parts in different relative positions;

FIG. 7 is a partial sectional view of the adapter assembly;

FIG. 8 is another partial sectional view of the adapter assembly;

FIG. 9 is a view similar to FIG. 3 illustrating one use of an insert that may form part of the adapter assembly;

FIGS. 10 and 11 are views illustrating an adapter assembly in accordance with a second embodiment of the invention; and

FIGS. 12 and 13 are views illustrating an adapter assembly in accordance with a third embodiment of the invention.

### DETAILED DESCRIPTION OF THE INVENTION

In one aspect, the present invention relates to an adapter assembly for a backrest for a wheelchair that is adjustable in both a front to back direction and in an angular direction, relative to the back canes of the wheelchair. The invention is applicable to wheelchairs and backrests and adapter assemblies of various differing constructions. As representative of the invention, FIG. 1 illustrates an adapter assembly (or adjuster) 10 that is a first embodiment of the invention, for supporting a backrest 12 on a wheelchair shown schematically at 14.

The wheelchair 14 illustrated in FIG. 1 includes a seat bottom cushion 16 for supporting the weight of an occupant of the wheelchair. The seat bottom cushion 16 is supported on a frame 20 that engages the floor via a plurality of wheels 22.

The wheelchair 14 includes left and right back canes 24. As used herein, the term back cane means the portion of the wheelchair 14 to which the backrest 12 is releasably attached. In the illustrated embodiment, the back canes 24 are frame portions that extend generally vertically at or near the back of the wheelchair 14. The back canes 24 are manually engageable by someone other than the occupant of the wheelchair 14, to push and steer the wheelchair. The back canes 24 are typically cylindrical tubes but could have other configurations.

The backrest 12 includes a cushion 30 that has upper and lower edge portions 32 and 34, a left side portion 36, and a right side portion 38. The cushion 30 has a front face 40 for engagement by the occupant of the wheelchair 14, and an opposite back face (not shown).

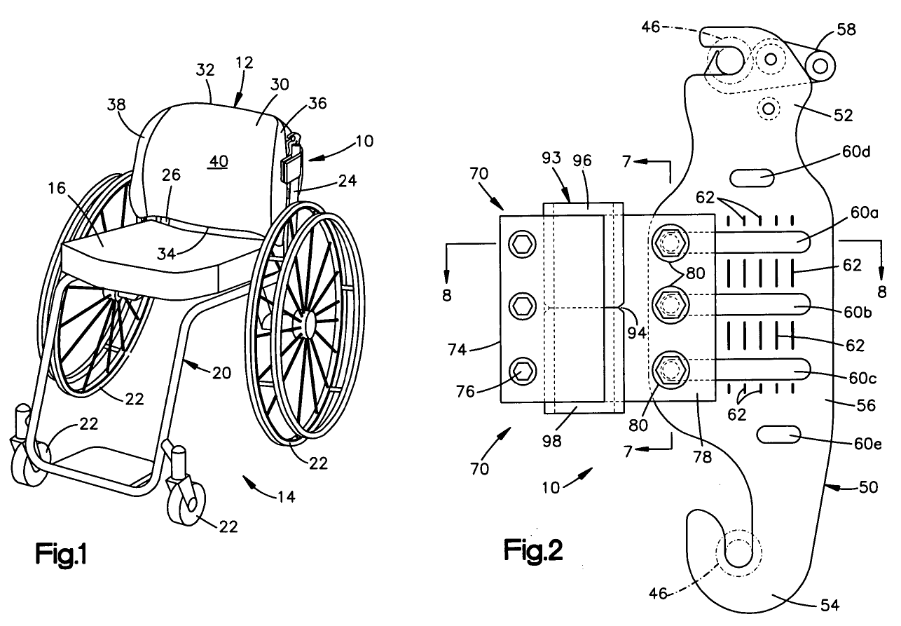

The backrest 12 has a plurality of mounting studs for helping to mount the cushion 30 on the back canes 24. In the illustrated embodiment, the backrest 12 includes two mounting studs 46 (FIG. 2) projecting laterally outward from the left side portion 36 of the cushion. The two studs 46 are spaced apart vertically along the left side portion 36 of the cushion 30 and are for use in releasably attaching the left side portion of the backrest 12 to the left back cane 24. The backrest 12 also includes two mounting studs (not shown) projecting laterally outward from the right side portion 38 of the cushion 30 for use in releasably attaching the right side portion of the backrest 12 to the right back cane 24.

Two adapter assemblies 10 are provided, for attaching the left and right side portions 36 and 38 of the backrest 12 to the left and right back canes 24, respectively. The two adapter assemblies 10 are mirror images of each other.

The adapter assembly 10 includes a bracket 50 and a clamp 70. The clamp 70 is designed to clamp onto the back cane 24. The bracket 50 is attached to the backrest 12. The clamp 70 is adjustably connected with the bracket 50. As a result, the backrest position of the backrest 12 can be adjusted relative to the back canes 24.

The bracket 50 is preferably formed as one piece from a strong, rigid material, such as steel or Delrin® brand plastic. The bracket 50 may, alternatively, be formed from several pieces. The bracket 50 has a generally flat, plate-like configuration including an upper end portion 52, a lower end portion 54, and a central portion 56. The lower end portion 52 of the bracket 50 is configured as a hook for receiving the lower mounting stud 36 on the backrest 12. The upper end portion 54 of the bracket 50 has a cam latch mechanism 58, for receiving the upper mounting stud 36 on the backrest 12.

The central portion 56 of the bracket includes a plurality of slots. The term “slot” refers to an opening in the bracket that receives a fastener or clamping member of some type, for the purpose of positional adjustment of the bracket 50 relative to the clamp 70.

In the illustrated embodiment, five slots, numbered 60a-60e, are provided. A different number of slots could, alternatively, be provided. The middle three slots 60a-60c are the same length as each other. The upper slot 60d and the lower slot 60e are the same length as each other. The upper slot 60d and the lower slot 60e are shorter than the middle three slots 60a-60c.

The slots 60 are parallel or substantially parallel to each other. The slots 60 extend in a direction transverse to the length of the bracket 50. Preferably, the slots 60 extend in a generally horizontal direction when the bracket 50 is mounted on the back cane 24 of the wheelchair 12, so that the slots extend in a front to back direction of the wheelchair.

In the illustrated embodiment, each one of the middle slots 60a-60c is about two inches in length. In the illustrated embodiment, each one of the middle slots 60a-60c is about five sixteenths of an inch in width. Each one of the upper and lower slots 60d and 60e is about one half inch in length and about five sixteenths of an inch in width.

The bracket includes indicia 62 adjacent to the slots 60. The indicia 62 are markings that enable a user of the adapter assembly 10 to locate the same position along the length of the three slots 60a-60c when adjusting the backrest 12.

The clamp 70 includes a clamp body 72. The clamp body 72 is preferably formed as one piece from the same material as the bracket. The clamp body 72 has a tubular cane portion 74 that has an adjustable diameter central opening for receiving the back cane 24. The cane portion 74 has three lock screws 76 for tightening the cane portion of the clamp body 72 onto the back cane 24.

The clamp body 72 has a mounting portion 78 for mounting the clamp body and the clamp 70 as a whole onto the bracket 50. The mounting portion 78 extends from the cane portion 74. The mounting portion 78 has a generally flat, plate-like configuration adapted to overlie and abuttingly engage the central portion 56 of the bracket 50. A plurality of fastener openings 79 are formed in the mounting portion 78. In the illustrated embodiment, three openings 79 are provided, the same as the number of middle slots 60a-60c in the bracket.

The adapter assembly 10 includes a plurality of mounting members or fasteners 80 for mounting the clamp 70 to the bracket 50. In the illustrated embodiment, three fasteners 80 are provided, the same as the number of openings 79 in the mounting portion 78 of the clamp body 72. In the illustrated embodiment, the fasteners 80 are socket head cap screws having head portions 82 and externally threaded shank portions 84.

The fasteners 80 are narrower than the middle slots 60. Specifically, the shank portions 84 of the fasteners 80 are sufficiently narrower than the slots 60 so that the clamp 70 can be pivoted relative to the bracket 50 through a substantial angular range, as described below. In one embodiment, the slots 60 have a width of five sixteenths of an inch, and the shank portions 84 of the screws 80 have a diameter (width) of about one quarter inch.

The clamp 70 also includes a nut 90 into which the fasteners 80 can be screwed. In the illustrated embodiment, the nut 90 is a plate having three threaded openings 92 adapted to threadedly receive the shank portions 84 of the screws 80. Other structures or devices could be provided for establishing the clamping connection with the fasteners 80.

The parts of the wheelchair 10 including the adapter assembly 10, the backrest 12 and the canes 24 may be assembled and adjusted in varying different manners and orders. One order of assembly is discussed herein.

The bracket 50 is loosely assembled to the clamp 70. Specifically, the three fasteners 80 are removed from the nut 90. The mounting portion 78 of the clamp body 72 is placed on the central portion 56 of the bracket 50.

The fasteners 80 are placed through the fastener openings 79 in the mounting portion 78 of the clamp body 72, and through the three middle slots 60a-60c in the bracket 50. The nut 90 is placed in a position overlying the bracket 50. The fasteners 80 are screwed into the nut 90, far enough to hold the parts together without being tight. The fasteners 80 are thus operatively located on the clamp 70.

The clamp 70 may then be assembled to the back cane 24. Specifically, the cane portion 74 of the clamp body 72 is placed over the back cane 24. The lock screws 76 are tightened to secure the clamp body 72 onto the back cane 24 at the desired vertical location along the back cane. The fasteners 80 are thus operatively located on the back cane 24.

The backrest 12 is then hooked onto the bracket 50. The slots 60 are thus operatively located on the backrest 12, in the sense that they are on the bracket 50 that clips to and moves with the backrest, as noted below.

The backrest adjustments can then be set. Specifically, because the fasteners 80 are not yet tightened into the nut 90, the bracket 50 can be slid in a forward and backward direction relative to the fasteners 84 and the clamp 80. The shank portions 84 of the fasteners 80 move in the slots 60 in a direction along or parallel to the length of the slots. This movement or adjustment sets the front to back position of the backrest 12 relative to the back cane 24. Once the desired position is attained, tightening the fasteners 80 into the nut 90 secures the backrest 12 in the selected front to back position relative to the back cane 24.

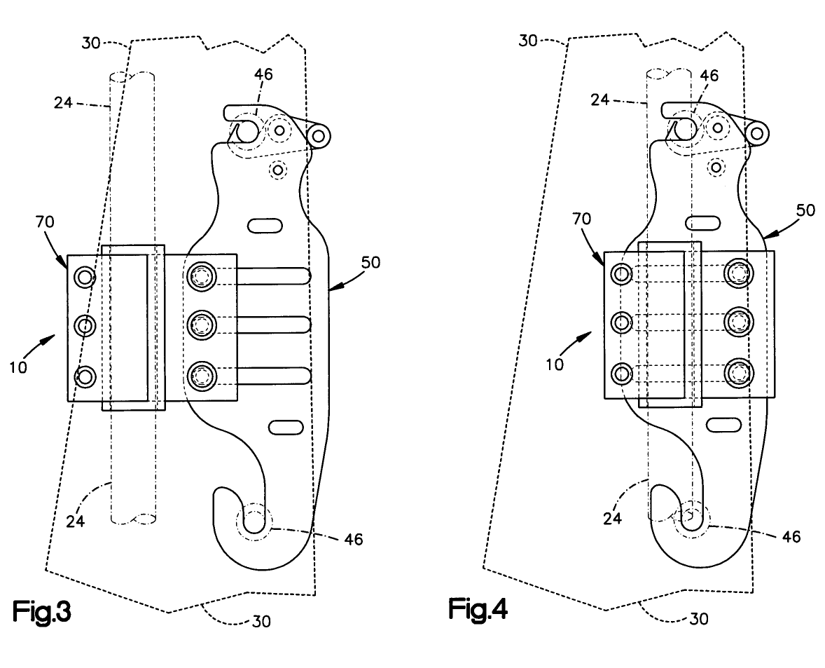

In addition, the backrest 12 can be positioned angularly relative to the back cane 24. Specifically, the clamp 70 can be pivoted relative to the bracket 50, as shown in FIGS. 3-6. When this occurs, the shank portions 84 of the fasteners 80 move in the slots 60a-60c in a direction transverse to the length of the slots. This transverse movement enables the pivoting movement of the clamp 70 relative to the bracket 50. Such pivoting movement is possible even though there are three fasteners 80 in three slots 60, because the fasteners are sufficiently narrower than the slots. For example, with the relative widths of the fasteners 80 and the slots 60c noted above, the clamp 70 can be pivoted relative to the bracket 50 through a range of angular adjustment of about thirty degrees.

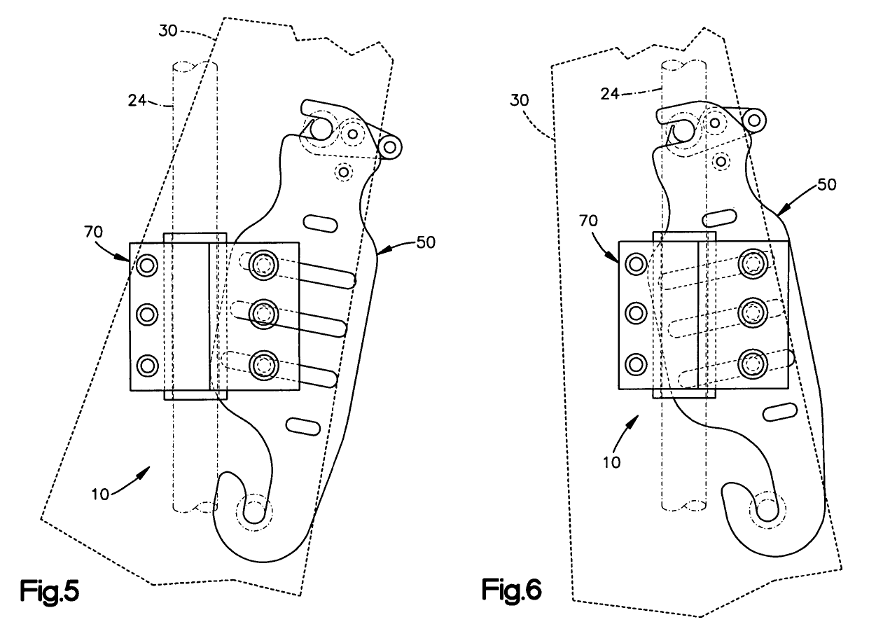

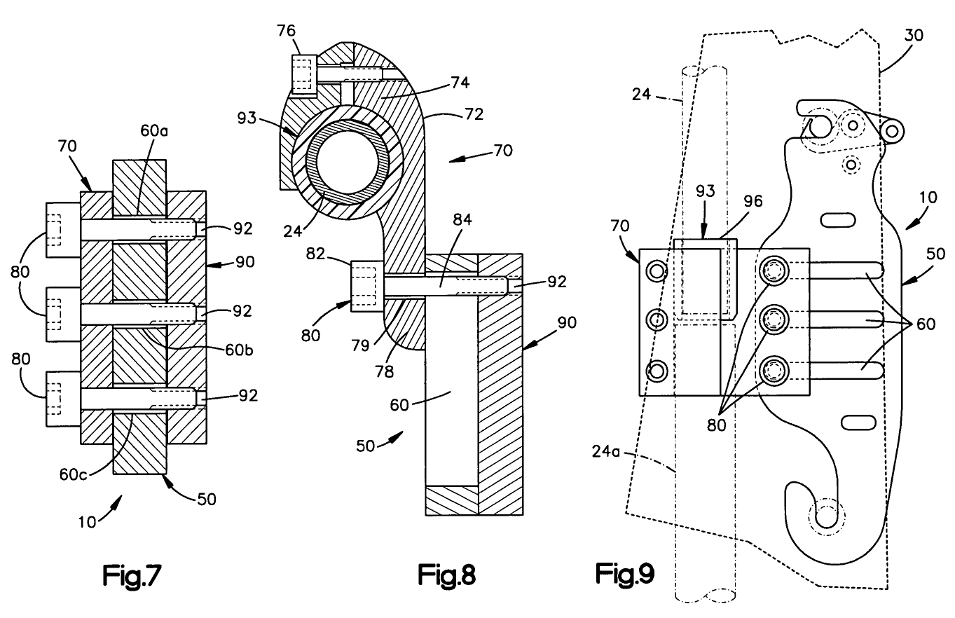

Several exemplary positions are shown in the drawings. FIGS. 2 and 3 shows the backrest 30 in a fully rearward position relative to the back cane 24, and in a substantially vertical orientation. FIG. 4 shows the backrest 30 in a fully forward position relative to the back cane 24, and in a substantially vertical orientation. FIG. 5 shows the backrest 30 in a substantially rearward position relative to the back cane 24, and in an orientation tipped backward at the top. FIG. 6 shows the backrest 30 in a substantially forward position relative to the back cane 24, and in an orientation tipped forward at the top. It should be noted that an extra amount of front to back adjustment is available by turning the clamp 70 around on the back cane 24. For example, as viewed in FIG. 2, the clamp 70 points to the left. The clamp 70 can be flipped around, 180 degrees, to give an extra 2.5 inches of fore and aft adjustment.

The angular adjustment of the clamp 70 relative to the bracket 50 sets the angular position of the backrest 12 relative to the back cane 24. The backrest 12 can be adjusted so that its front face 40 is generally vertical, or with the top edge 32 farther forward, or with the bottom edge 34 farther forward.

Once the desired angular orientation of the backrest 12, and its front to back position, are both located, the mounting screws 80 are tightened into the nut 90. The bracket 50 is clamped between the heads 82 of the mounting screws 80 and the nut 90. The clamp 70 is secured in position on the bracket 50. The backrest 12 is thereby secured in position on the back cane 24.

In some cases it may be desirable to adjust the “yaw” of the backrest 12 so that it is not purely lateral on the wheelchair 12. Thus, one side portion 36 or 38 of the backrest cushion 30 can be set to a relatively more forward position than the other side portion. The front to back positioning adjustment on one side of the backrest 12 is independent of the front to back positioning adjustment on the other side of the backrest.

Both the angular adjustment and the front to back adjustment of the backrest 12 are set by the same fasteners 80. Loosening the fasteners 80 enables both settings to be adjusted simultaneously by adjusting the relative positions of the bracket 50 and the clamp 70.

In the particular illustrated embodiment, the three middle slots 60a-60c are the slots that are normally used. If it is desired to have the bracket higher or lower on the clamp, the mounting members could be positioned with one in the upper slot 60d or the lower slot 60e. The slots 60d and 60e are shorter because there is less room for them on the bracket. Because these slots 60d and 60e are shorter, there may be less room for adjustment when they are used. In other bracket configurations, additional slots could be longer or shorter. Also, a different number of slots can be used.

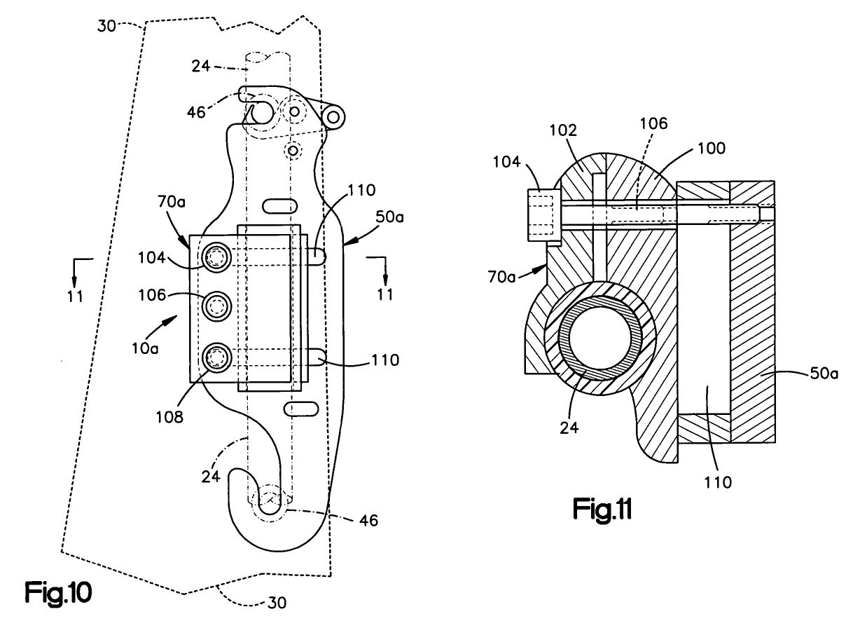

In the preferred embodiment, a tubular plastic insert 93 is located in the tubular central opening of the cane portion 74 of the clamp body 70. The insert 93 has an inner diameter sized to accept the appropriate back cane 24. Some wheelchairs have different sized back canes. To accommodate this, the insert 93 has a groove 94 at its longitudinal center, to enable the insert easily to be cut or otherwise split into two pieces 96 and 98. When this is done, one piece only of the insert can be used, as shown in FIG. 9, for example. In this manner, the clamp 70 can accommodate a back cane 24 of a smaller diameter in the portion of the clamp having the insert 93, while a back cane 24a of a larger diameter can be accommodated in the portion of the clamp that does not have the insert.

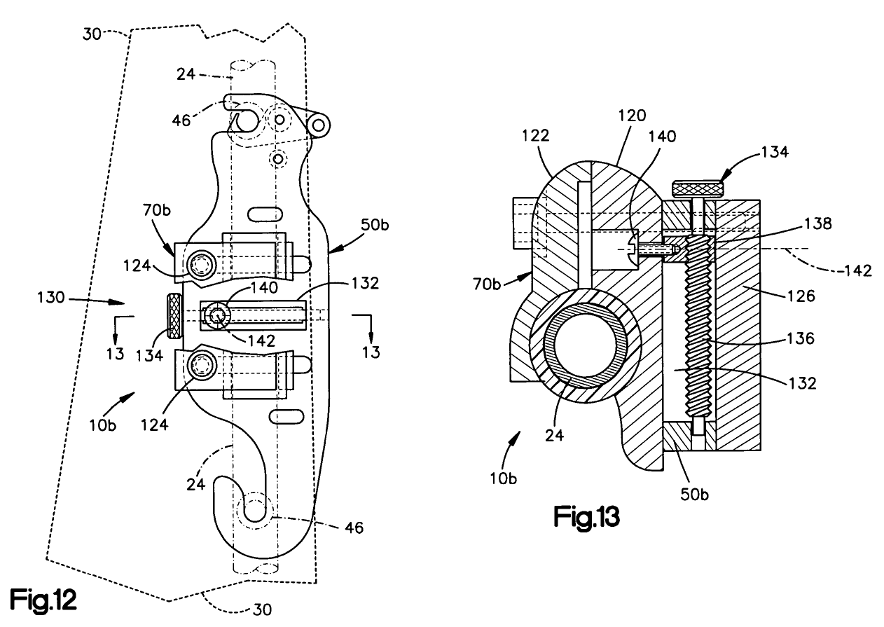

FIGS. 10 and 11 illustrate schematically an adapter assembly 10a that is a second embodiment of the invention. The adapter assembly 10a includes a bracket 50a and a clamp 70a. The bracket 50a is similar to or identical to the bracket 50 described above.

The clamp 70a includes first and second clamp parts 100 and 102 that are joined by three fasteners 104, 106 and 108 preferably in the form of bolts or screws. The inner fastener 104 extends only through the two clamp parts 100 and 102 and does not extend into or through the bracket 50a. The outer two fasteners 106 and 108 extend not only through the clamp parts 100 and 102 but also into slots 110 in the bracket 50a.

The clamp parts 100 and 102 are held together on the back cane 24 as shown in FIG. 11 by the three fasteners 104, 106 and 108. The outer two fasteners 106 and 108 can be loosened and the bracket 50a moved relative to the clamp 70a, without affecting the vertical position of the clamp on the back cane 24 of the wheelchair. Separate screws (or groups of screws) for the two functions of clamping to the back cane 24 and of clamping the bracket 50a to the clamp 70a, are not needed.

FIGS. 12 and 13 illustrate schematically an adapter assembly 10b that is a third embodiment of the invention. The adapter assembly 10b includes a bracket 50b and a clamp 70b. The bracket 50b may be similar to the bracket 50 described above.

The clamp 70b includes first and second clamp parts 120 and 122 that are releasably joined by two locking fasteners 124 preferably in the form of bolts or screws. The two fasteners 124 extend through through holes in both clamp parts 120 and 122 and can be tightened into a nut plate 126 on the back of the bracket 50b. When the two fasteners 124 are tightened, the clamp 70b is held securely in position on the bracket 50b, and the backrest position is set relative to the back cane. When the two fasteners 124 are loosened, the clamp 70b is movable relative to the bracket 50b, to set both the front to back position and the angular position of the backrest relative to the back cane.

The adjuster assembly 10b includes also a depth adjustment mechanism 130. Specifically, the bracket 50b includes a middle slot 132. A depth adjuster screw 134 is mounted on the bracket 50b for rotation, but not axial movement, relative to the bracket 50b. The threaded shank 136 of the screw 134 is received in a drive nut 138 supported for sliding movement in the middle slot 132. The nut 138 is connected by a nut retainer 140 for movement with the inner clamp part 120.

When the two locking fasteners 124 are loose, rotation of the depth adjuster screw 134 causes the drive nut 138 to move axially in the slot 132. The motion of the nut 138 is transmitted through the nut retainer 140 to the inner clamp part 120. As a result, the clamp 70b moves with the drive nut 138 in a direction along the length of the slot 132. When the position of the clamp 70b is set, the locking fasteners 124 can be tightened to secure the clamp 70b in the selected position.

The clamp 70b is pivotable relative to the drive nut 138. For example, the connection between the nut retainer 140 and the drive nut 138 may enable pivoting or rotational movement of the clamp 70b relative to the drive nut about an axis 142 extending transverse to the length of the slot 132. As a result, the clamp 70b as a whole is pivotable relative to the bracket 50b, to enable the desired angular adjustment between the clamp 70b and the bracket 50b.

Many variations on the particular illustrated embodiments are feasible in accordance with the invention. For example, the slots could be located on the clamp rather than on the bracket. In this case, the mounting members or fasteners or pins would be located on the bracket or other structure that attaches to the backrest. As another example, more than 5 slots or fewer than 5 slots could be provided. Further, an extra amount of front to back adjustment is available by turning the clamp around on the back cane. Such changes, modifications and variations within the skill of the art are intended to be covered by the appended claims.

Having described the invention, we claim:

1. An adapter assembly for releasably attaching a backrest to a back cane of a wheelchair, comprising:
a clamp that can be releasably clamped on the back cane;
a bracket that can be releasably engaged with the backrest, the bracket having a plurality of openings; and
a plurality of fasteners that extend from the clamp through the openings in the bracket, the fasteners having a first condition securing the bracket from movement relative to the clamp and having a second condition enabling adjustment of both the front to back position and the angular position of the backrest relative to the back cane.

2. An adapter assembly as set forth in claim 1 wherein the openings are large enough relative to the fasteners to allow the fasteners to pivot as a group in the openings without being removed from the openings.

3. An adapter assembly as set forth in claim 1 wherein the openings are large enough relative to the fasteners to enable adjustment of the angular position of the backrest relative to the back cane by at least about 25° or more.

4. An adapter assembly as set forth in claim 3 wherein the fasteners are threaded fasteners having shank portions that extend through the openings in the bracket into one or more nuts.

5. An adapter assembly as set forth in claim 1 wherein the bracket has at least three openings and there are at least three of the fasteners extending through the openings.

6. An adapter assembly as set forth in claim 1 wherein the at least three openings are parallel slots.

7. An adapter assembly as set forth in claim 1 wherein the plurality of fasteners also secure the clamp to the back cane.

8. An adapter assembly as set forth in claim 7 further including at least one additional fastener that secures the clamp to the back cane and that does not extend from the clamp through the openings in the bracket.

9. An adapter assembly as set forth in claim 7 further including a depth adjuster mechanism.

10. An adapter assembly as set forth in claim 9 wherein the depth adjuster mechanism includes a drive nut connected with the clamp for driving the clamp for front and back movement relative to the bracket, the clamp being pivotable relative to the drive nut to enable angular adjustment of the backrest relative to the back cane.

11. A backrest assembly for a personal mobility device, comprising:
a backrest having mounting members on first and second side portions; and
first and second adapter assemblies for releasably attaching the first and second side portions of the backrest to first and second frame members, respectively, of the personal mobility device, each one of the adapter assemblies comprising:
a clamp that can be releasably clamped on the frame member;
a bracket that can be releasably engaged with the backrest, the bracket having a plurality of openings; and
a plurality of fasteners that extend from the clamp through the openings in the bracket, the fasteners having a first condition securing the bracket from movement relative to the clamp and having a second condition enabling adjustment of both the front to back position and the angular position of the backrest relative to the frame member.

12. A backrest assembly as set forth in claim 11 wherein the first and second frame members are back canes of a wheelchair

13. A backrest assembly as set forth in claim 12 wherein the backrest mounting members are studs projecting from the side portions of the backrest.

14. A backrest assembly as set forth in claim 11 wherein the openings are large enough relative to the fasteners to allow the fasteners to pivot as a group in the openings without being removed from the openings.

15. A backrest assembly as set forth in claim 11 wherein the openings are large enough relative to the fasteners to enable adjustment of the angular position of the backrest relative to the back cane by at least about 25° or more.

16. A backrest assembly as set forth in claim 16 wherein the fasteners are threaded fasteners having shank portions that extend through the openings in the bracket into one or more nuts.

17. A backrest assembly as set forth in claim 11 wherein the bracket has at least three openings and there are at least three of the fasteners extending through the openings.

18. A backrest assembly as set forth in claim 11 wherein the at least three openings are parallel slots.

19. A backrest assembly as set forth in claim 11 wherein the plurality of fasteners also secure the clamp to the back cane.

20. A backrest assembly as set forth in claim 19 further including at least one additional fastener that secures the clamp to the back cane and that does not extend from the clamp through the openings in the bracket.

21. An adapter assembly as set forth in claim 19 further including a depth adjuster mechanism.

22. An adapter assembly as set forth in claim 21 wherein the depth adjuster mechanism includes a drive nut connected with the clamp for driving the clamp for front and back movement relative to the bracket, the clamp being pivotable relative to the drive nut to enable angular adjustment of the backrest relative to the back cane.

23. A personal mobility device comprising:
a frame including first and second frame members;
wheels connected with the frame for enabling movement of the device along a ground surface;
a backrest supported on the first and second frame members; and
first and second adapter assemblies for releasably attaching the backrest to the first and second frame members, each one of the adapter assemblies comprising:
a clamp that can be releasably clamped on the frame member;
a bracket that can be releasably engaged with the backrest, the bracket having a plurality of openings; and
a plurality of fasteners that extend from the clamp through the openings in the bracket, the fasteners having a first condition securing the bracket from movement relative to the clamp and having a second condition enabling adjustment of both the front to back position and the angular position of the backrest relative to the frame member.

24. A personal mobility device as set forth in claim 23 wherein the openings are large enough relative to the fasteners to allow the fasteners to pivot as a group in the openings without being removed from the openings.

25. A personal mobility device as set forth in claim 23 wherein the openings are large enough relative to the fasteners to enable adjustment of the angular position of the backrest relative to the back cane by at least about 25° or more.

26. A personal mobility device as set forth in claim 17 wherein the fasteners are threaded fasteners having shank portions that extend through the openings in the bracket into one or more nuts.

27. A personal mobility device as set forth in claim 23 wherein the bracket has at least three openings and there are at least three of the fasteners extending through the openings.

28. A personal mobility device as set forth in claim 23 wherein the at least three openings are parallel slots.

29. A personal mobility device as set forth in claim 23 wherein the plurality of fasteners also secure the clamp to the back cane.

30. A personal mobility device as set forth in claim 29 further including at least one additional fastener that secures the clamp to the back cane and that does not extend from the clamp through the openings in the bracket.

31. An adapter assembly as set forth in claim 29 further including a depth adjuster mechanism.

32. An adapter assembly as set forth in claim 31 wherein the depth adjuster mechanism includes a drive nut connected with the clamp for driving the clamp for front and back movement relative to the bracket, the clamp being pivotable relative to the drive nut to enable angular adjustment of the backrest relative to the back cane.

33. A method of changing the position of a side portion of a wheelchair backrest relative to a wheelchair back cane, the wheelchair including two fasteners that are operatively located on a first one of the backrest and the back cane and that are received in two generally parallel slots operatively located on the second one of the backrest and the back cane, the method comprising the steps of:
making the front to back position and the angular position of the backrest side portion adjustable relative to the back cane by loosening the two fasteners;
moving the fasteners in the slots thereby to adjust one or both of the front to back position and the angular position of the backrest side portion relative to the back cane; and
tightening the fasteners thereby to secure the backrest side portion in the selected position relative to the back cane.

34. A method as set forth in claim 33 wherein the step of moving the fasteners in the slots comprises moving the fasteners in the slots in a direction transverse to the length of the slots thereby to change the angular orientation of the backrest side portion relative to the back cane.

35. A method as set forth in claim 33 wherein the two fasteners are operatively located on the back cane and the slots are operatively located on the backrest.

36. A method as set forth in claim 33 wherein said step of loosening the two fasteners comprises loosening two fasteners that help to secure the backrest to the back cane, without making the backrest adjustable on the back cane.

37. An adapter assembly for releasably attaching a wheelchair backrest to a back cane of a wheelchair, comprising:
a clamp that can be releasably engaged with the back cane; and
a bracket that can be releasably engaged with the backrest;
the bracket having a plurality of parallel slots extending in a front to back direction of the bracket when the bracket is attached to the back cane of the wheelchair; and
a plurality of fasteners engageable in the slots to connect the bracket with the clamp and thereby to attach the backrest to the back cane;
the fasteners being slidable along the length of the slots to adjust the front-to-back position of the backrest relative to the back cane;
the fasteners being narrower than the slots to allow the clamp and the fasteners to pivot relative to the bracket to adjust the angular position of the backrest relative to the back cane.

38. An adapter assembly as set forth in claim 37 wherein the fasteners are sufficiently narrower than the slots to enable angular adjustment of the backrest relative to the back cane by at least about 25° or more.

39. An adapter assembly as set forth in claim 37 wherein the fasteners have a tightened condition in which the clamp is fixed in position relative to the bracket and a loosened condition in which the clamp is movable relative to the bracket.

40. An adapter assembly as set forth in claim 39 wherein the fasteners are threaded fasteners having shank portions that extend through the slots

41. An adapter assembly as set forth in claim 37 wherein the bracket has at least three of the parallel slots and the assembly includes at least three of the fasteners.

42. An adapter assembly for releasably attaching a wheelchair backrest to a back cane of a wheelchair, comprising:
a clamp that can be releasably engaged with the back cane;
a bracket that can be releasably engaged with the backrest; and
means selectively movable between a first condition securing the bracket from movement relative to the clamp and a second condition enabling adjustment of both the front to back position and the angular position of the backrest relative to the back cane.

43. An adapter assembly as set forth in claim 42 wherein said means comprises a plurality of fasteners extending through a plurality of openings in said bracket.

44. An adapter assembly as set forth in claim 42 wherein the fasteners are operatively located on a first one of the bracket and the clamp and the openings are operatively located on a second one of the bracket and the clamp.

45. An adapter assembly as set forth in claim 44 wherein the fasteners are operatively located on the clamp and the openings are operatively located on the bracket.
